(19) United States
(12) Patent Application Publication
(10) Pub. No.: US 2015/0221014 A1
(43) Pub. Date: Aug. 6, 2015

(54) CLUSTERED BROWSE HISTORY

(71) Applicants: Jonathan Gabbai, London (GB); James Tenniswood, Eltham (GB)

(72) Inventors: Jonathan Gabbai, London (GB); James Tenniswood, Eltham (GB)

(73) Assignee: EBAY INC., SAN JOSE, CA (US)

(21) Appl. No.: 14/170,194

(22) Filed: Jan. 31, 2014

(51) Int. Cl. G06Q 30/06; H04L 29/08; G06F 17/30

(52) U.S. Cl. CPC G06Q 30/0629; G06F 17/30598; G06F 17/3089; H04L 67/22

(57) ABSTRACT

In various example embodiments, a system and method for determining an item group and generating a group representation for the item group are provided. Accordingly, item data associated with a user may be accessed. The item data may include item temporal data. Item relationships between pieces of the item data corresponding to items may be identified. The item relationships may include a temporal relationship that may be based on the item temporal data. An item group associated with the items may be determined based on the item relationships. A group representation corresponding to the item group may be generated. The group representation may summarize the items associated with the item group. The methods and systems may cause presentation of the group representation to the user.

### TECHNICAL FIELD

Embodiments of the present invention relate generally to interactively providing information, and more particularly, but not by way of limitation, to interactively presenting summarized item groups.

### BACKGROUND

Given the vast amount of information available in electronic form and the limited capacity of a person to consume information, searches are performed to find and display portions of available information. Conventionally, the results from a search are displayed in a list where each result appears one after another. Inefficiencies may arise in seeking relevant results in the list as a person evaluates each result in the list individually and scans low-level details to find relevant results.

### BRIEF DESCRIPTION OF THE DRAWINGS

Various ones of the appended drawings merely illustrate example embodiments of the present invention and cannot be considered as limiting its scope.

FIG. 1 is a block diagram of a networked system depicting an example embodiment.

FIG. 2 is a block diagram depicting an example embodiment of a summarizing system.

FIG. 3 is a block diagram depicting a data structure, according to example embodiments.

FIG. 4 is a block diagram depicting an item group, according to example embodiments.

FIG. 5 is a flow diagram illustrating an example embodiment for summarizing and presenting an item group.

FIGS. 6, 7, 8, 9, and 10 are flow diagrams further illustrating example embodiments for grouping items.

FIG. 11 is a flow diagram illustrating an example embodiment for compiling and storing a group file.

FIGS. 12, 13, and 14 are flow diagrams illustrating example embodiments for interacting with group representations.

FIG. 15 depicts example user interfaces for presenting group representations.

FIG. 16 is an example embodiment of a computer system in conjunction with the present inventive subject matter.

### DETAILED DESCRIPTION

The description that follows includes systems, methods, techniques, instruction sequences, and computing machine program products that embody illustrative embodiments of the invention. In the following description, for the purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments provide systems and methods to summarize item data corresponding to items at various levels of information density, allowing the user to scan information at a high-level. For example, a user may perform a search for an item, or many searches for different items over time, and the item data returned by the search may be grouped and summarized at various information resolutions. In other embodiments, item data may be access from browsing (e.g., items listed on an online marketplace), emails (e.g., promotional emails may be associated with items), and so forth. In an example embodiment, the item data may include various data corresponding to items, the items may be associated with item groups by identifying relationships between the items based on the item data, a group representation may be generated for each item group at a group resolution, and the group representation may be interactively presented to the user. The group representations may, for example, be a combination of images and text that summarizes the items associated with the item group. The group representations may be presented to the user, allowing for the user to quickly determine the items associated with the item group and find a particular item without having to scan the low-level detail of the search results.

In an example embodiment, the items may be associated with the item groups based on a variety of item relationships. For example, item relationships, such as temporal relationships (e.g., close in time) and similarity relationships (e.g., same type, same brand, and so forth), between the items may be identified and used to associate items with item groups. Further examples include item engagement data (e.g., various metrics providing an indication of the user's interests in an item), item conversion data (e.g., whether the browsing session resulted in a purchase), item data source (e.g., user initiated search, promotional item, and so forth), and other data that may be used to identify the item relationships.

The group representations may summarize the items associated with the item group using a variety of information in a variety of ways. In an example embodiment, the group representations may be generated with a range of different resolutions. For example, a high-resolution group representation may include many details (e.g., images and text) summarizing the items associated with the item group. In another example, a low-resolution group representation may include few details summarizing the item group. In some example embodiments, the user may interact with the group representation. For example, the user may activate a group representation and, responsive to the activation, additional information related to the item group may be presented (e.g., a listing of the items associated with the item group or a more detailed summary of the items associated with the item group). In a further embodiment, the user interaction with the group representation may be stored and used to generate group representations in the future.

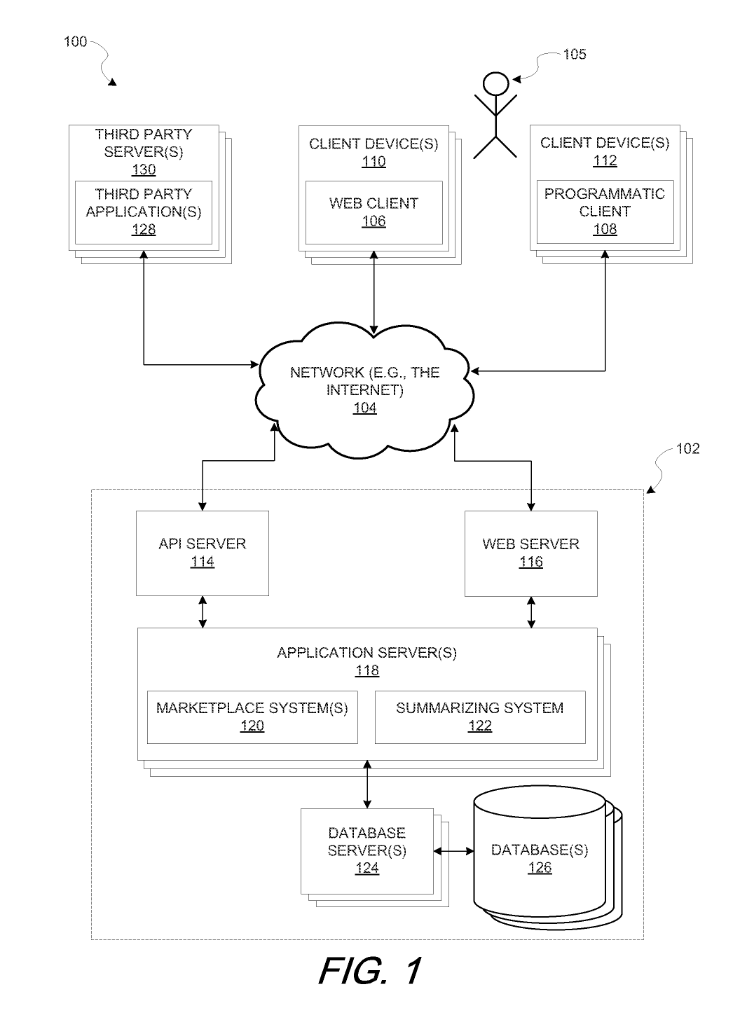

With reference to FIG. 1, an example embodiment of a high-level client-server-based network architecture 100 is shown. A networked system 102, in the example forms of a network-based marketplace or payment system, provides server-side functionality, via a network 104 (e.g., the Internet or Wide Area Network (WAN)) to one or more client devices 110 and 112. FIG. 1 illustrates, for example, a web client 106 (e.g., a browser, such as the Internet Explorer browser developed by Microsoft Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some example embodiments, the client device 110 may comprise a display module (not shown) to display information (e.g., in the form of user interfaces). In further embodiments, the client device 110 may comprise one or more of a touch screen, accelerometer, gyroscope, camera, microphone, and GPS device. The client devices 110 and 112 may be a device of a user that is used to perform a transaction involving digital goods within the networked system 102. In one embodiment, the networked system 102 is a network-based marketplace that manages digital goods, publishes publications comprising item listings of products available on the network-based marketplace, and manages payments for these marketplace transactions. One or more users 105 may be a person, a machine, or other means of interacting with client devices 110 and 112. In embodiments, the user 105 is not part of the network architecture 100, but may interact with the network architecture 100 via client devices 110 and 112 or another means.

An Application Program Interface (API) server 114 and a web server 116 are coupled to, and provide programmatic and web interfaces respectively to, one or more application servers 118. The application servers 118 may host one or more marketplace systems 120 and summarizing system 122, each of which may comprise one or more modules or applications and each of which may be embodied as hardware, software, firmware, or any combination thereof. The application servers 118 are, in turn, shown to be coupled to one or more database servers 124 that facilitate access to one or more to one or more information storage repositories or database(s) 126. In an example embodiment, the databases 126 are storage devices that store information to be posted (e.g., publications or listings) to the marketplace system 120. The databases 126 may also store digital goods information in accordance with example embodiments.

The marketplace system(s) 120 may provide a number of marketplace functions and services to users that access the networked system 102. The summarizing system 122 may likewise provide a number of summarizing, item grouping, and interactive presentation services and functions to users. The summarizing system 122 may present items, available via the marketplace system(s) 120, and group items based on various relationships between. While the marketplace system(s) 120 and summarizing system 122 are shown in FIG. 1 to both form part of the networked system 102, it will be appreciated that, in alternative embodiments, each system 120 and 122 may form part of a payment service that is separate and distinct from the networked system 102. In some example embodiments, the summarizing system 122 may form part of the marketplace system 120.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various marketplace and summarizing systems 120 and 122 could also be implemented as standalone software programs, which do not necessarily have networking capabilities.

The web client 106 accesses the various marketplace and summarizing systems 120 and 122 via the web interface supported by the web server 116. Similarly, the programmatic client 108 accesses the various services and functions provided by the marketplace and summarizing system 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

Additionally, a third party application(s) 128, executing on a third party server(s) 130, is shown as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

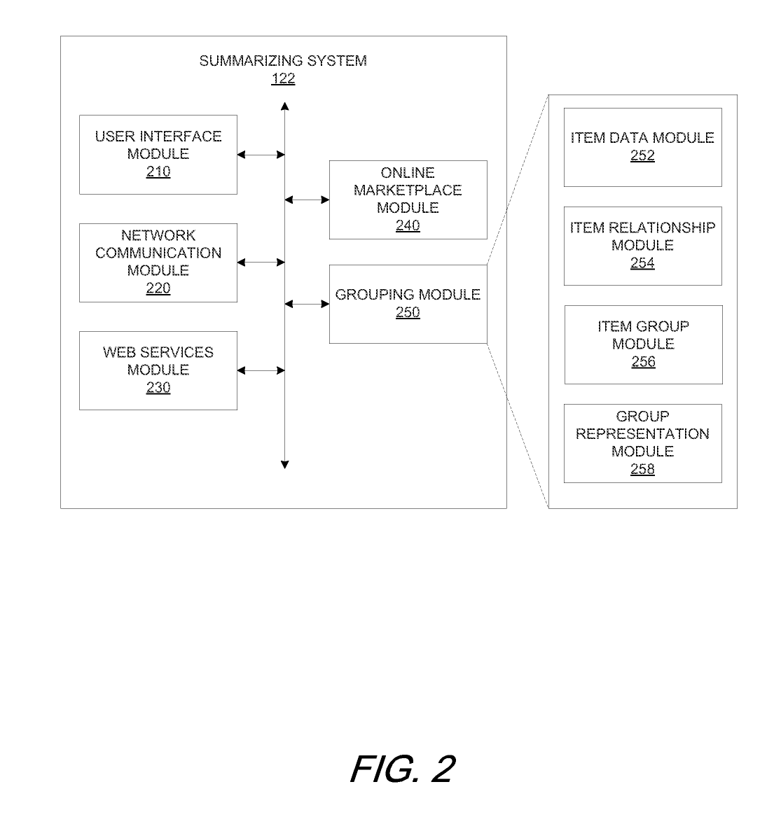

FIG. 2 is a block diagram of the summarizing system 122, which may summarize item groups by generating group representations, group items, and interactively present the group representations to the user. In an example embodiment, the summarizing system 122 may include a user interface module 210, a network communication module 220, a web services module 230, an online marketplace module 240, and a grouping module 250. In some example embodiments, the grouping module 250 may include an item data module 252, an item relationship module 254, an item group module 256, and a group representation module 258. All of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 210 may provide various user interface functionality operable to interactively present and receive information from the user. For example, the user interface module 210 may provide a user interface to receive a search query from the user and present the results of the search query to the user (e.g., searching for an item and displaying the results of the search). Information may be presented using a variety of means including visually displaying information and using other device outputs (e.g., audio, tactile, and so forth). Similarly, information may be received by a variety of means including alphanumeric input or other device input (e.g., one or more touch screen, camera, tactile sensors, light sensors, infrared sensors, biometric sensors, microphone, gyroscope, accelerometer, other sensors, and so forth). It will be appreciated that the user interface module 210 may provide many other user interfaces to facilitate functionality described herein. Presenting may mean communicating information to a device (e.g., client devices 110 and 112), the device having functionality operable to perform presentation using the communicated information. Interactively presenting may mean the exchange of information from the presenting device, the user, and the summarizing system 122.

The network communication module 220 may perform various network communication functions such as communicating with the client devices 110 and 112 and servers such as the application servers 118, the database servers 124, and the third party servers 130. Network communication may operate over WiFi, Bluetooth, or other means of wired or wireless data transmission.

The web services module 230 may perform various web services functions such as retrieving information from third party servers 130 and application servers 118. Information retrieved by the web services module 230 may include data associated with the user (e.g., user profile information from an online account, social networking data associated with the user, and so forth), data associated with an item (e.g., images of the item, reviews of the item, and so forth), and other data.

The online marketplace module 240 may communicate with and exchange data with an online marketplace such as the marketplace system 120. The online marketplace module 240 may retrieve item listings and other data associated with the item listings (e.g., images, description, price, weight, dimensions, availability, and so forth), user profile information, account information, and the like. In some example embodiments, the online marketplace module 240 may request execution of a search query from marketplace system 120 and receive search query results from the marketplace system 120. A variety of other information may be exchanged between the marketplace system 120 and the online marketplace module 240.

The grouping module 250 may perform various item grouping and summarizing functions. In an example embodiment, the grouping module 250 may access the item data associated with the user, identify item relationships between items, determine items associated with the item groups, and generate a group representation summarizing the items associated with the item group. The group representation may be presented to the user using the user interface module 210.

The item data module 252 may access the item data from various sources. In an example embodiment, the item data module 252 may access information from an application server (e.g., a third party website), a database (e.g., databases 126), the online marketplace (e.g., marketplace system(s) 120 on application server 118), and other sources. In further embodiments, the item data module 252 may exchange information with a database (e.g., databases 126) such as storing and retrieving the user's interactions with the group representation. In yet another embodiment, the item data module 252 may compile an assortment of information into a file, store the file, communicate the file, communicate the information included in the file, and retrieve information from the file in the future.

The item relationship module 254 may identify item relationships between the items using the item data. For example, a temporal relationship between the items may be identified using the temporal data associated with the items (e.g., items associated with a timestamp within the past week). A variety of schemes may be employed to identify the item relationships.

The item group module 256 may determine items associated with the item group based on the item relationships. Various schemes may be employed using a variety of information to determine items associated with the item group using the item relationships.

The group representation module 258 may generate the group representation that summarizes the items associated with the item group. The group representation may include one or more images, text, other media, and other information. A variety of schemes using various data may be employed to generate the group representation.

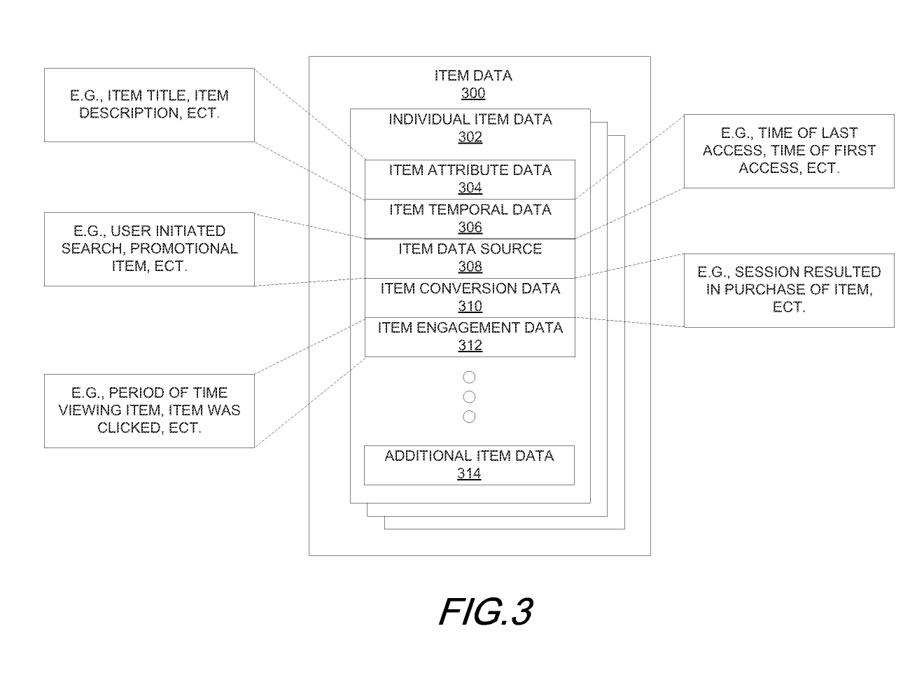

FIG. 3 is a block diagram illustrating a data structure, according to example embodiments. The item data 300 may include one or more individual item data 302. The individual item data 302 may include data corresponding to a particular item. For example, the item data 300 may include the individual item data 302, which may include item attribute data 304 and item temporal data 306 corresponding to the items. The item attribute data 304 may include information such as item title, item description, item price, item images, brand, dimensions, availability of the item, social network posts associated with the item, reviews associated with the item, whether the item is perishable, whether the item is time sensitive (e.g., a concert ticket that has no value after the concert), and so forth. The item temporal data 306 may include information such as the first access time, most recent access time, a complete record of all accesses, frequency of accesses, when the item first became available, and so forth. In some example embodiments, the item data 300 may include item data source 308 (e.g., user initiated action, promotional items, items related to other items in the item data 300, and so forth), item conversion data 310 (e.g., whether the browsing session resulted in a purchase), item engagement data 312 (e.g., various metrics providing an indication of the user's interest in an item such as time spent viewing an item, social posts by the user that reference the item, social posts by friends of the user that reference the item, and so forth), and the like. In some example embodiments, additional item data 314 may be included in the item data 300. The additional item data 314 may include images, items related to the item, reviews of related items, social networking information such as friends of the user that purchased the item, and so forth.

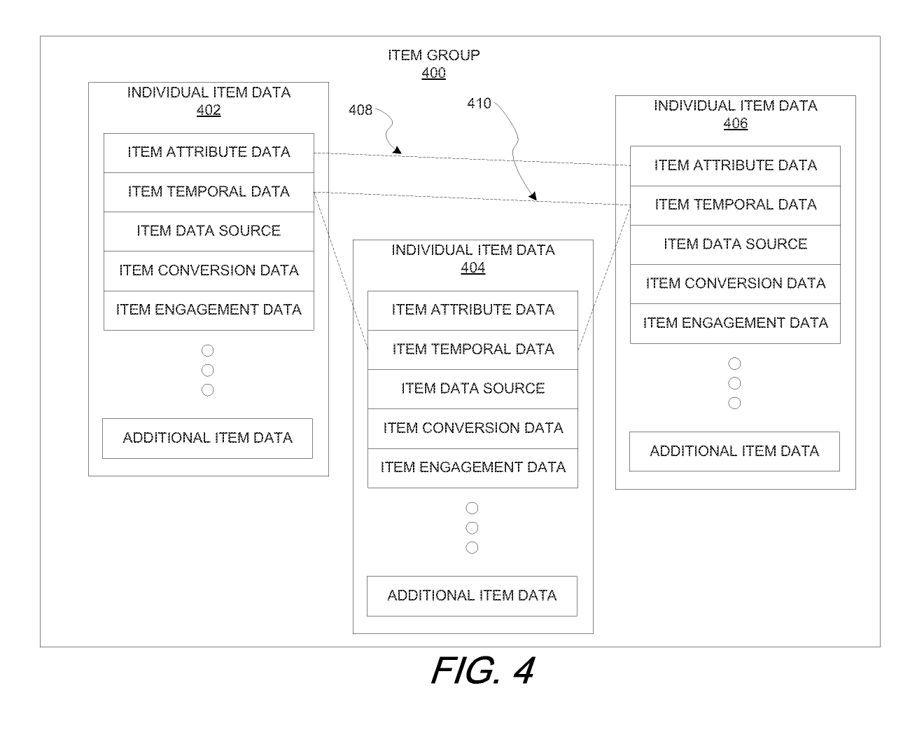

FIG. 4 is a block diagram depicting an example embodiment of an item group 400. In some example embodiments, the item group 400 may be associated with one or more items and the items may be associated with one or more items groups. Associated may mean to map particular items to the item group. In other words, the item group may map to one or more of the items. The item group 400 is an example item group associated with three items although item group 400 may be associated with any number of items. The items associated with the item group 400 may correspond to individual item data such as individual item data 402, 404, and 406. The item group 400 may be determined based on the item relationships such as relationship 408 and relationship 410, for example. For instance, the item group 400 may specify that each item that is associated with the item group 400 have a temporal relationship to the other items associated with the item group 400. The item relationships may be based on various data included in the item data 402, 404, and 406. For example, the relationship 408 may be based on the item attribute data. In this example, a similarity relationship may be identified between the items that have similar item attribute data. In another example, the relationship 408 may be based on the item temporal data. In this example, a temporal relationship may be identified between the items that have proximate temporal data. In a specific example, the temporal relationship may be items that are associated with temporal data within a certain time period (e.g., all items associated with a timestamp that is within the last 24 hours). Many schemes may be employed using a variety of data included in the item data to identify the item relationships.

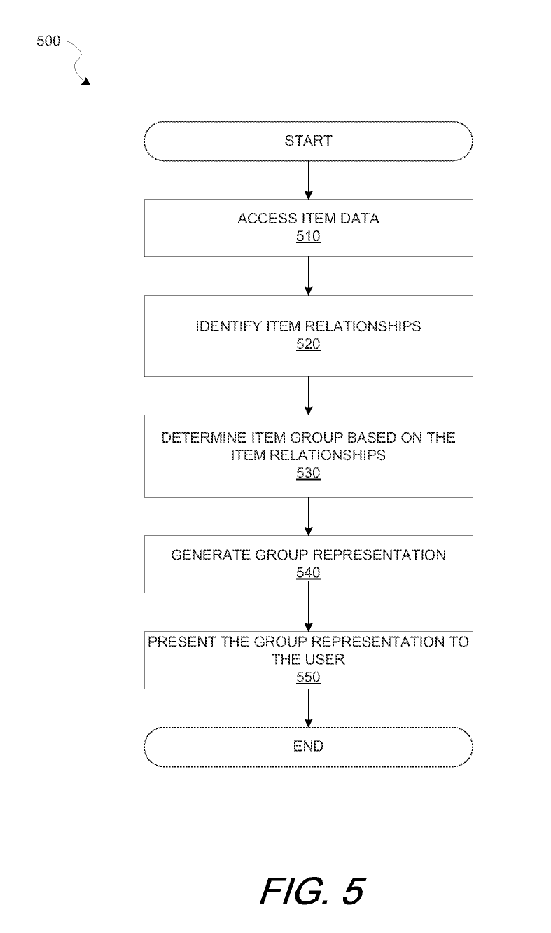

FIG. 5 is a flow diagram illustrating an example method 500 for summarizing item data by grouping items, generating a group representation, and presenting the group representation to the user. The method 500 may be performed by the components of summarizing system 122. At operation 510, the summarizing system 122 may access the item data 300 associated with the user, using the item data module 252. The item data 300 may be accessed from a query history of the user, a purchase history of the user, the third party servers 130, the marketplace system(s) 120, and other sources. For example, the user may have performed a number of search queries for items at the marketplace system(s) 120. The search queries, search results, and other information associated with the search queries (e.g., date and time the query was executed) may be stored in a storage device such as databases 126. The summarizing system 122 may access the query history of the user, including all of the information associated with the query, including the query results that include the item data. In further embodiments, the item data 300 may be access from browsing data (e.g., items listed on an online marketplace), email data (e.g., an email account of the user that includes promotional emails that may be associated with items), social networking data (e.g., social networking posts that are associated with items or promotional items), and so forth.

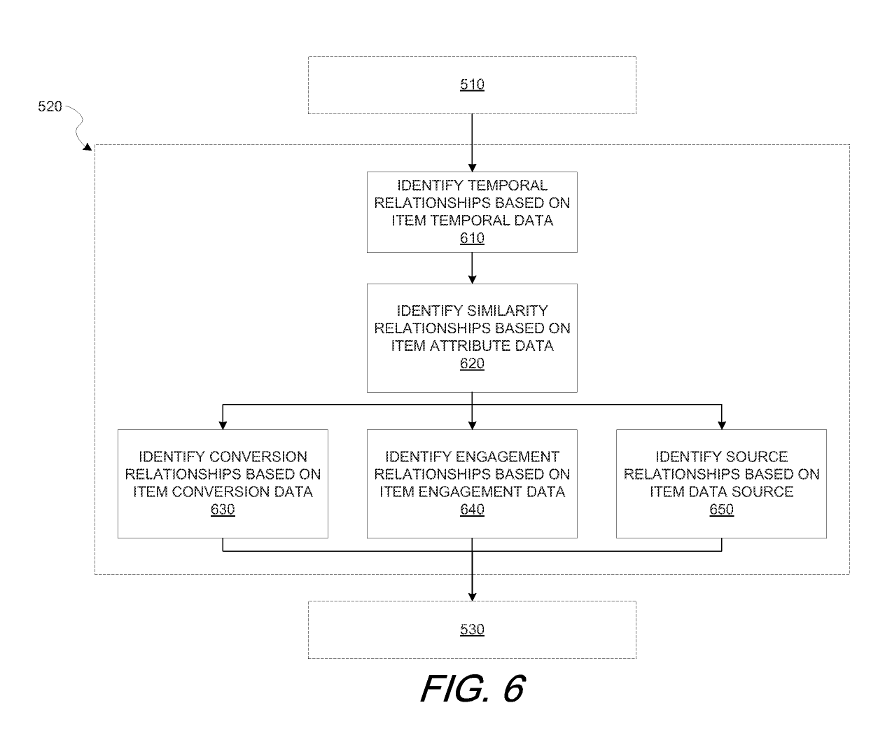

At operation 520, the summarizing system 122, using the item relationship module 254, may identify the item relationships between the items as further described in FIG. 6. For example, the temporal relationships based on the item temporal data and the similarity relationships based on the item attribute data may be identified. In further embodiments, other item relationships may be identified such as item source relationships, item conversion relationships, engagement relationships, and so forth.

In further embodiments, the grouping module 250 may determine group relationships between item groups based on the items associated with the item groups. Similar to the item relationships, the group relationships may employ the schemes and techniques of the item relationships and other schemes and techniques. The group relationships may be used, for example, to sort the item groups, combine groups, subdivide groups, or exchange information between item groups.

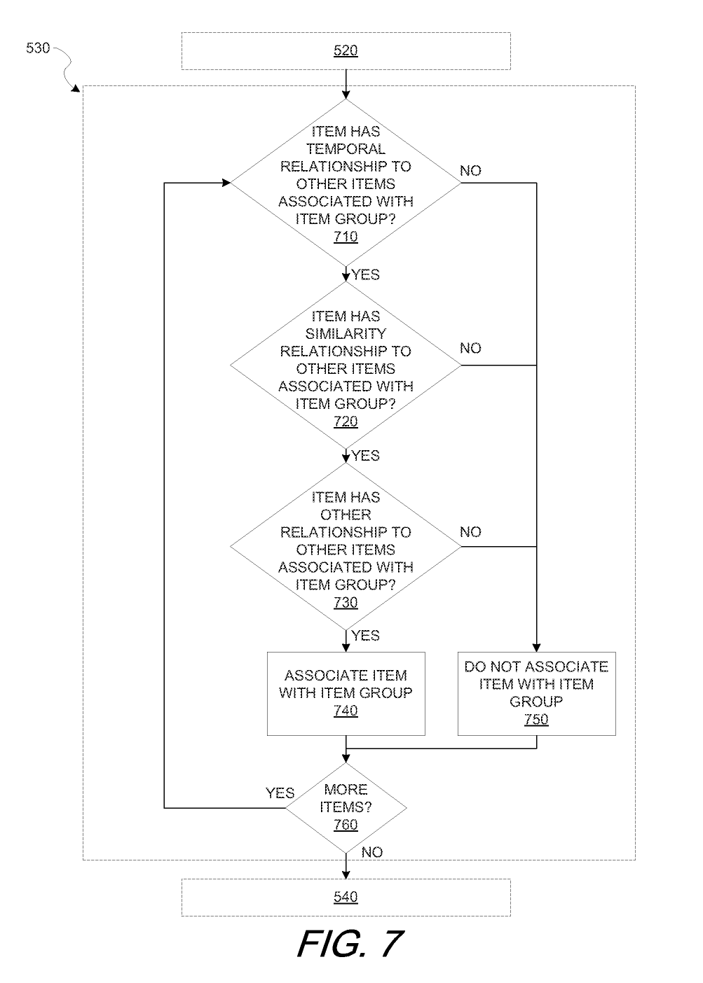

At operation 530, the summarizing system 122 may determine, using the item group module 256, the item group associated with at least a portion of the items based on the item relationships as further described in FIG. 7. Various schemes may be employed to determine the item group using a variety of information. For example, the user profile information, the item data, prior user interactions with the group representation data, item groups of other users, and other data may be used to determine the item group. In some example embodiments, the item group may be determined using the item data associated with item groups of other users. For example, other users may have performed similar searches to the user and the item groups of other users determined. The item groups of other users may have been modified by the other users through interactions with the item group. The item group may be determined using information from the item groups of the other users.

In further embodiments, the summarizing system 122, using the item group module 256, may identify additional items related to the items associated with the item group. The additional items may be associated with the item group. For example, if the item group is associated with items related to shoes, the item group module 256 may identify shoes related to the shoes associated with the item group. The additional items may be promotional items, similar items with different brands, similar items with a lower cost, and so forth. Item listings corresponding to the additional items may be retrieved, using, for example, item data module 252, from the online marketplace (e.g., marketplace system(s) 120) and the item data may include data corresponding to the additional items.

In still further embodiments, the summarizing system 122, using the item group module 256, may use user profile information or other information to determine the items associated with the item group. The user profile information and other information may be retrieved, using the item data module 252, from the marketplace system(s) 120, the third party servers 130, and so forth. For example, the user profile information may contain information such as user name, user demographic information, and the like. In a specific example, the user profile information may include gender information, and the gender information may be used to determine items to associate with the item group, such as gender specific apparel. A variety of other information may be retrieved from a variety of sources and used to determine items to associate with the item group.

In yet further embodiments, the summarizing system 122, using the item group module 256, may automatically generate a similar item group to the item group determined at the operation 530. The similar item group may be associated with items that are similar to the items associated with another item group. For example, if the item group is associated with items from a user query, a similar item group may be generated that is associated with items similar to the items associated with the user query. In this example, the similar item group may be associated with items such as promotional items, high conversion rate items, items the summarizing system 122 may predict the user may be interested in, and so forth.

In some example embodiments, the summarizing system 122, using the item group module 256, may determine subgroups associated the item group based on the item relationships. For example, if the item group is based on the temporal relationships, the subgroups associated with the item group may be identified based on similarity relationships. Similar to the item group, the subgroups may have subgroup representations, similar to the group representations, and may be interacted with by the user, similar to the group representations. Any feature or functionality that may be employed for the item group may likewise be employed for the subgroup. In further embodiments, there may be subgroups within subgroups and so on.

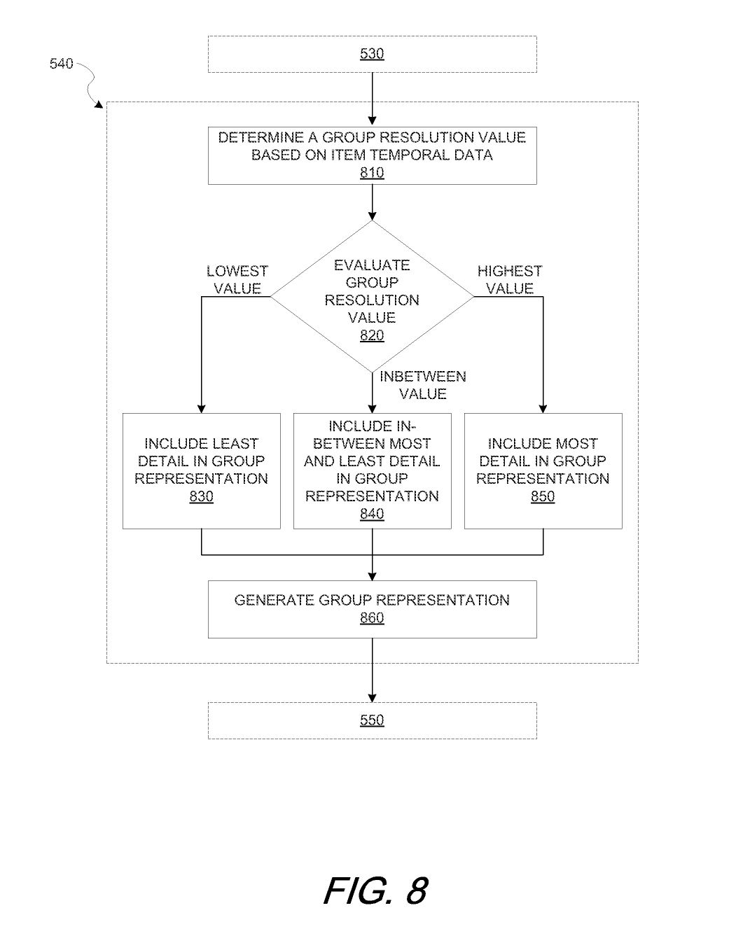

At operation 540, the summarizing system 122 may generate, using group representation module 258, a group representation corresponding to the item group as further depicted in FIGS. 8, 9, and 10. The group representation may summarize the items associated with the item group. The group representations may be presented to the user to provide a high-level view of the items associated with the item group. The high-level view may allow the user to quickly identify items associated with the item group without having to scan low-level details. The group representation may be, for example, an image, text, or a combination of text and images that represents the items associated with the item group. For a specific example, if the item group is associated with various assortments of footwear, the item group may be represented by an image of a shoe. In some example embodiments, the group representation may be generated using data included in the item data. In further embodiments, the group representation may be generated using group representations of other users.

In still further embodiments, the summarizing system 122, using the group representation module 258, may use the user profile information or the other information to generate the group representation. For example, the user profile information may include the gender information and the gender information may be used to generate the group representation with gender specific images and text (e.g., women's clothing for women). A variety of other information may be retrieved from a variety of sources and used to generate the group representation.

At operation 550, the summarizing system 122, using the user interface module 210, may present the group representation, which summarizes the items associated with the item group, to the user, allowing the user to quickly identify items associated with the item group. In an example embodiment, the group representation may be provided, using the user interface module 210, to the client devices 110 and 112, and the client devices 110 and 112 may present the group representation to the user. In other example embodiments, the summarizing system 122 may present the group representation to the user, using, for example, the user interface module 210. Many variations of providing and presenting the group representation may be employed by the summarizing system 122. In some example embodiments, the group representations may be sorted based on the item temporal data associated with the group representation. For instances, the group representations may be sorted by most recent to least recent. Sorting may further assist the user in quickly finding items of interest. In other embodiments, the group representations may be sorted based on other data.

FIG. 6 is a flow diagram further depicting an example embodiment of the operation 520. As described herein, the operation 520 may identify the item relationships using the item data corresponding to the items. At operation 610, the summarizing system 122 may identify the temporal relationships based on the item temporal data using the item relationship module 254. For example, the item temporal data may include a date and a time associated with an item (e.g., a time when a search for the item was performed). The temporal data may be used in a variety of schemes to identify relationships between items. For a specific example, a relationship between the items may be identified if the date and times associated with the items are within a certain time period. The time period may be fixed or dynamically determined based on an analysis of the item temporal data. Many other schemes and techniques may be employed to identify the relationships between the items based on the temporal data.

At operation 620, the summarizing system 122 may identify, using the item relationship module 254, similarity relationships based on item attribute data. For example, the item attribute data may include item titles. In this example, a relationship between the items may be identified if the titles are an exact match or contain the same or similar text. In another example, the item attribute data may include a brand name. A relationship between the items may be identified if the brands are the same or similar. Various keyword-matching techniques between item descriptions may also be employed to identify the similarity relationships. Many other possible schemes and techniques may be employed to identify relationships between items based on the attribute data. In some example embodiments, relationships between the items based on the item attribute data may only be identified if a temporal relationship between the items has been identified. In other embodiments, the temporal relationship between the items is not necessary to identify relationships based on attribute data.

At operation 630, the summarizing system 122 may identify, using the item relationship module 254, conversion relationships based on the item conversion data. For instances, a relationship between items may be identified if the items have a high conversion rate (e.g., the browsing session often results in a purchase when presenting the item). The conversion rate may be specific to the user or based on other users. In some example embodiments, the conversion relationships may only be identified if various other relationships have first been identified. In other embodiments, the conversion relationships may be identified without the prerequisite of other relationships.

At operation 640, the summarizing system 122, using the item relationship module 254, may identify engagement relationships based on the item engagement data. For example, a relationship between the items may be identified if the items have a high engagement rate as determined by factors such as time spent viewing an item, click behavior associated with an item, and other factors. The engagement rate may be specific to the user or based on other users. In some example embodiments, the engagement relationships may only be identified if various other relationships have first been identified. In other embodiments, the engagement relationships may be identified without the prerequisite of other relationships.

At operation 650, the summarizing system 122, using the item relationship module 254, may identify source relationships based on the item data source. For example, a relationship between items may be identified if the items were retrieved from the same source such as a user-initiated search. In some example embodiments, the source relationships may only be identified if various other relationships have first been identified. In other embodiments, the source relationships may be identified without the prerequisite of other relationships.

FIG. 7 is a flow diagram further depicting an example embodiment of the operation 530. As described herein, the operation 530 may determine the item group based on the item relationships. At operation 710, the summarizing system 122, using the item group module 256, may determine if the item has a temporal relationship to other items associated with the item group. For example, if the item has a temporal relationship to other items associated with the item group, then the item may be associated with the item group or further analysis may be performed to determine whether to associate the item with the item group. In this example, if the item does not have a temporal relationship to the items associated with the item group, the item may not be associated with the item group (operation 750). In some example embodiments, where there are no items associated with the item group, the item may be associated with the item group, or in other embodiments, the item may not be associated with the item group.

In an example embodiment, the item group may be associated with items based on the temporal data corresponding to the items being within a temporal range (e.g., a time period). The temporal range may be pre-defined or dynamically determined based on the temporal data. The temporal range may overlap with other temporal ranges. In a specific example, the temporal range for the item group may increase as the temporal data is farther in the past. In other words, if the temporal range is associated with temporal data near the present, the temporal range may encompass a shorter time span, and if the temporal range is in the distant past, the temporal range may encompass a longer time span. Many other schemes may be employed to determine the item group based on temporal relationships and temporal data.

If it is determined at operation 710 that the item has a temporal relationship to other items associated with the item group, then operation 720 is performed. At operation 720, the summarizing system 122, using the item group module 256, may determine if the item has a similarity relationship to other items associated with the item group. For example, if it is determined that the item has a similarity relationship to other items associated with the item group, the item may be associated with the item group and operation 730 is performed, or further analysis may be performed to determine whether to associate the item with the item group. In this example, if the item does not have a similarity relationship to the items associated with the item group, the item may not be associated with the item group (operation 750). In some example embodiments, where there are no items associated with the item group, the item may be associated with the item group, or in other embodiments, the item may not be associated with the item group.

Likewise, at operation 730, the summarizing system 122, using the item group module 256, may determine if the item has other relationships to other items associated with the item group. The other relationships may include the conversion relationships, the engagement relationships, the source relationships, and other relationships based on various data. For example, if it is determined that the item has other relationships to other items associated with the item group, the item may be associated with the item group in operation 740, or further analysis may be performed to determine whether to associate the item in the item group. In this example, if the item does not have other relationships to the items associated with the item group, the item may not be associated with the item group (operation 750). In some example embodiments, where there are no items associated with the item group, the item may be associated with the item group, or in other embodiments, the item may not be associated with the item group.

At operation 740, the summarizing system 122, using the item group module 256, may associate the item with the item group. In an example embodiment, any number of items may be associated with the item group, and items may be associated with any number of the item groups.

At operation 750, the summarizing system 122, using the item group module 256, may not associate the item in the item group. In some example embodiments, items may be disassociated with the item group after having been associated with the item group although this is not depicted.

At operation 760, the summarizing system 122, using the item group module 256, may determine whether there are more items to process. In an example embodiment, if there are more items to process, the operations 710, 720, and 730 may be performed for another item. In some example embodiments, each item with data included in the item data may be processed, and in other embodiments, a portion of the items with data included in the item data may be processed.

FIG. 8 is a flow diagram further depicting an example embodiment of the operation 540. As described herein, the operation 540 may generate the group representation. The group representation may be generated with different resolutions pertaining to the information density of the group representation. For example, a high-resolution group representation may include many details associated with the items, and a low-resolution group representation may include few details associated with the items. The group representations with different resolutions may allow the user to scan information at different information densities. This will allow the user to view both low-level detail and high level summaries of the items associated with the item group.

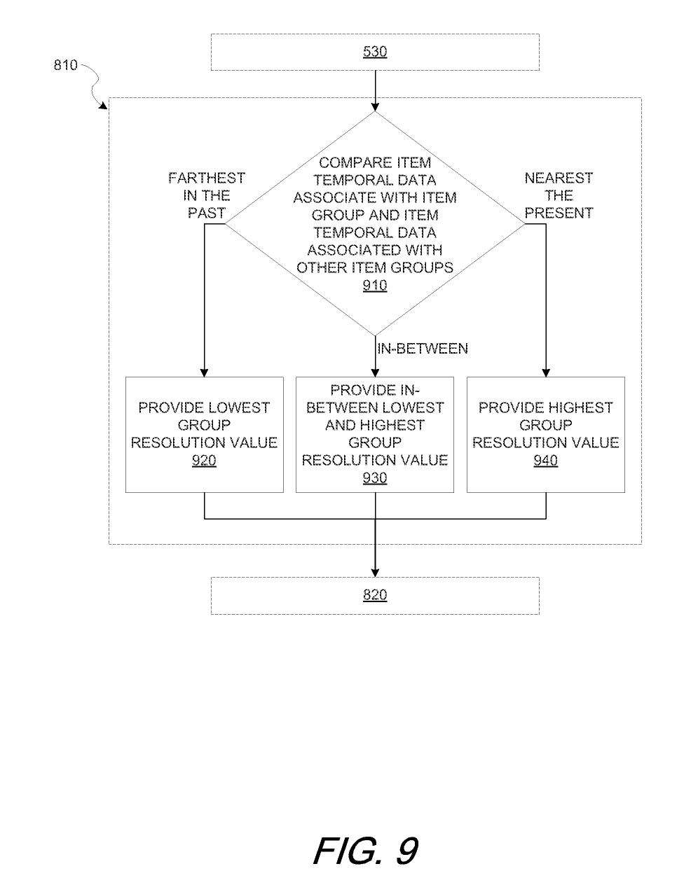

At operation 810, in an example embodiment, the summarizing system 122, using the group representation module 258, may determine a group resolution value based on the item temporal data. Determining the group resolution value is further depicted in FIG. 9. In an example embodiment, the group resolution value may be a numerical value, for example a value between zero and one. In other embodiments, the group resolution value may be determined based on other data. For example, the group resolution value may be determined based on the number of items associated with the item group, the screen area available for the presentation of the group representation, various item conversion metrics, various item engagement metrics, and so forth.

At operation 820, the summarizing system 122, using the group representation module 258, may evaluate the group resolution value. In an example embodiment, the group resolution value is a numerical value, and the group resolution value may be evaluated by determining whether the group resolution value is within a range of values. In some example embodiments, the range of values may be fixed or dynamically determined. The amount of detail relating to the items associated with the group representation may correspond to the group resolution value. In some example embodiments, a lower group resolution value may include less detail while a higher group resolution value may include more detail. The detail may be details relating to the items associated with the group representation. For example, the detail may be the general category of items, the brands of items, images of items, the price of items, textual descriptions of items, and so forth.

Provided the lowest group resolution value, at operation 830, the summarizing system 122, using the group representation module 258, may include the least detail in the group representation, in an example embodiment. For example, the least detail may mean simply a text summary of the items associated with the item group. For a specific example, if the items associated with the item group includes an assortment of shoes, the group representation may be text that is a general reference to shoes, such as footwear or shoes. In some example embodiments, the group representation may be an image that relates generally to the items associated with the group representation. In the above example, the group representation may be an image of a shoe or an image relating to shoes.

Provided a group resolution value in-between the lowest and highest group resolution value, at operation 840, the summarizing system 122, using the group representation module 258, may include more than the least detail and less than the most detail in the group representation, in an example embodiment. For example, the group representation corresponding to the group resolution value in-between the lowest and the highest group resolution value may include text and images whereas the group representation corresponding to the lowest group resolution may include only text. Many levels of group representation detail may be employed for the range of values between the lowest group resolution value and the highest group resolution value.

Provided the highest group resolution value, at operation 850, the summarizing system 122, using the group representation module 258, may include the most detail in the group representation, in an example embodiment. For example, the most detail may include a text title summarizing the items associated with the item group, a text description summarizing the items associated with the item group, one or more images summarizing or relating to the items associated with the item group, and so forth.

At operation 860, the summarizing system 122, using the group representation module 258, may generate the group representation that summarizes the items associated with the item group. The group representation may be generated using the group resolution value. Many different schemes may be employed to generate the group representation. For example, the item attribute data may include item categories. If a portion of the items associated with the item group correspond to an item category, the group representation may be the item category text. In some example embodiments, keywords may be extracted from the item attribute data and used to generate the group representation. In further embodiments, the item attribute data may include item images, and one or more of the item images may be used to generate the group representation. In some example embodiments, where there is more than one item associated with the item group, a representative item may be selected based on various analyses of various information (e.g., an item with a high conversion rate, an item with a high user engagement rate, and so forth) and information (e.g., text and images) associated with the selected item may be used as the group representation. In other embodiments, a summary description may be automatically generated using keywords extracted from the item data, and the summary description may be used as the group representation. In still further embodiments, predefined group representations may be stored and an appropriate predefined group representation identified based on the items associated with the item group. In yet further embodiments, the user or other users may create a group representation for a group of items, the group representation being stored and used in the future for the item groups with the same or similar included items. In some example embodiments, keywords may be extracted from the item attribute data and images or text relating to the extracted keywords may be retrieved from a third party application server, the retrieved text or images being used to generate the group representation. Many other schemes and techniques using a variety of data from a variety of sources may be employed to generate the group representation.

FIG. 9 is a flow diagram further depicting an example embodiment of the operation 810. As described herein, the operation 810 may determine the group resolution value based on the item temporal data associated with the item group and the item temporal data associated with other item groups. At operation 910, the item temporal data associated with the item group may be compared to the item temporal data associated with the other item groups. The comparison may include comparing differences in time between temporal data. For example, the temporal data associated with the item group may be recent (e.g., within one day of the present) while the temporal data associated with the other item groups may be further in the past (e.g., several weeks ago). In some example embodiment, the range of time encompassed by the item temporal data may be included in the comparison. For example, the item temporal data associated with the item group may encompass a smaller range of time (e.g., two days) as compared to the item temporal data associated with the other item groups (e.g., one month). In some example embodiments, the comparison may be relative to other item temporal data. In other embodiments, the item temporal data may be compared against predetermined values.

Provided item temporal data that is farthest in the past, at operation 920, the summarizing system 122, using the group representation module 258, may provide the lowest group resolution value. For example, if the range of group resolution values is between 0 and 1, the value 0 may be provided.

Provided item temporal data that is in-between the farthest in the past and nearest to the present item temporal data, at operation 930, the summarizing system 122, using the group representation module 258, may provide an in-between the lowest and the highest group resolution value. For example, if the range of group resolution values is between 0 and 1, the value 0.5 may be provided if the item temporal data is halfway between the farthest in the past and the nearest to the present item temporal data. In some example embodiments, the group resolution value may correspond linearly to the position of the item temporal data as compared to the farthest in the past and nearest to the present item temporal data. Similarly, in other embodiments, a logarithmic relationship or exponential relationship may be employed. In yet other embodiments, the group resolution value may be heuristically determined based on the item temporal data. Many different schemes and techniques may be employed to determine the in-between group resolution value based on the item temporal data.

Provided item temporal data that is nearest to the present, at operation 940, the summarizing system 122, using the group representation module 258, may provide the highest group resolution value. For example, if the range of group resolution values is between 0 and 1, the value 1 may be provided.

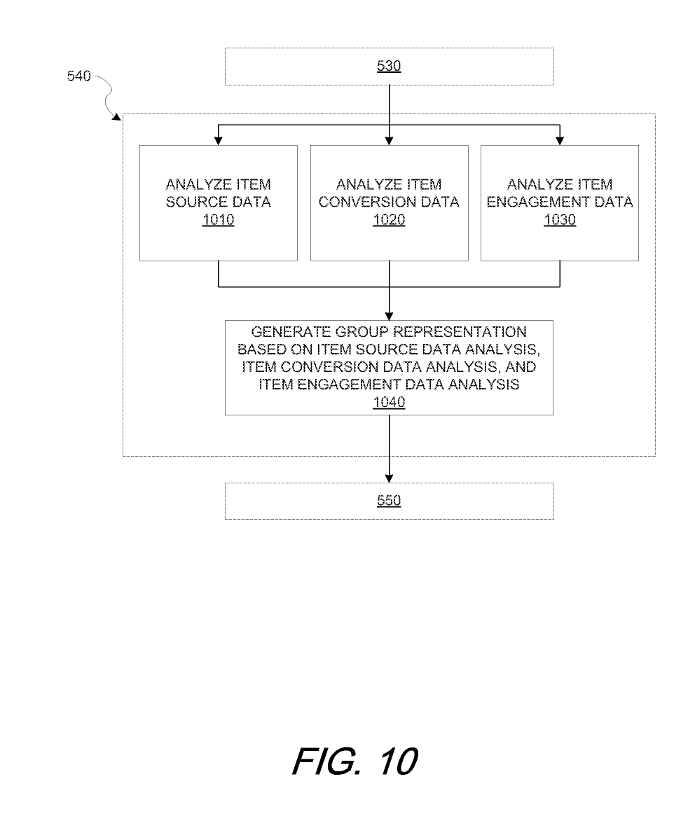

FIG. 10 is a flow diagram further depicting an example embodiment of the operation 540. As described herein, the operation 540 may generate the group representation. The group representation may be generated by analyzing data from various sources. Emphasis or weighting may be placed on various aspects of the group representation. For example, if the group representation is associated with a number of different items and analysis determines that several of those items may be of interest to the user, the group representation may prominently display those items of interest to the user. Emphasizing items based on various analyses may assist the user in finding pertinent items when scanning the group representations. Many schemes and techniques may be employed to generate the group representations using the analysis of various data.

At operation 1010, in an example embodiment, the summarizing system 122, using the group representation module 258, may analyze the item data source associated with the item group. The item data source may be used when generating the group representation. For example, the item group may be associated with plurality of items, and the item data corresponding to each item may have been accessed from a different source. In this example, a portion of the item data corresponding to the items may have been accessed from a user-initiated search and a portion of the item data corresponding to the items may be promotional items. In some example embodiments, weighting or emphasis may be employed when generating the group representation for different item data sources (e.g., emphasis may be placed on item data from user-initiated searches as opposed to promotional sources).

Similarly, at operation 1020, the summarizing system 122, using the group representation module 258, may analyze the item conversion data. The group representation may be generated using the item conversion data analysis to generate the group representation with weighting or emphasis on items associated with the item group that are likely to result in a purchase, for example. The group representation may be generated using the item conversion data analysis in a variety of schemes.

Likewise, at operation 1030, the summarizing system 122, using the group representation module 258, may analyze the item engagement data. The group representation may be generated using the item engagement data analysis to generate the group representation with weighting or emphasis on items associated with the item group that the user has shown interest in, for example. The group representation may be generated using the item engagement data analysis in a variety of schemes.

At operation 1040, the summarizing system 122, using the group representation module 258, may generate the group representation based on the item data source analysis, item conversion data analysis, the item engagement data analysis, and other data analysis. Various schemes and techniques may be employed to generate the group representation using the various data analyses. For example, the item group may include a plurality of items. For example, weighting or emphasis may be placed on certain items associated with the item group based on the data analyses to generate a group representation that is based on the items the user may be interested in, items the user is likely to purchase, promotional items, and so forth.

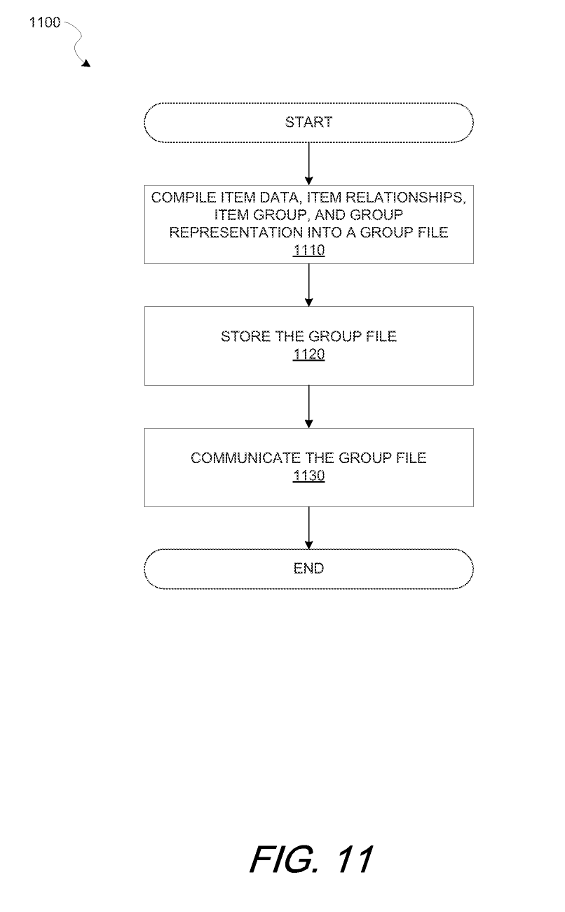

FIG. 11 is a flow diagram depicting an example embodiment of compiling and storing a group file. A group file may include the group representation and various data associated with the group representation. The group files may be communicated to various devices of the user to allow the user to view the group representations generated at an earlier time on another device.

At operation 1110, the summarizing system 122, using the item data module 252, may compile the item data, the item relationships, the item groups, and the group representations into a group file.

At operation 1120, the summarizing system 122, using the item data module 252, may store the group file. The group file may be stored, for example, in databases 126. In some example embodiments, the group file may be stored on client devices 110 and 112.

At operation 1130, the summarizing system 122, using the item data module 252, may communicate the group file. For example, the group file may be communicated to client devices 110 and 112. In embodiments, the group file may be communicated responsive to a group file request from the user. In further embodiments, the information included in the group file may be communicated responsive to a request from the user. In some example embodiments, the group file or information included in the group file may be accessed by the summarizing system 122. In this embodiment, the summarizing system 122 may have functionality operable to provide the group representation or information included in the group file to the user.

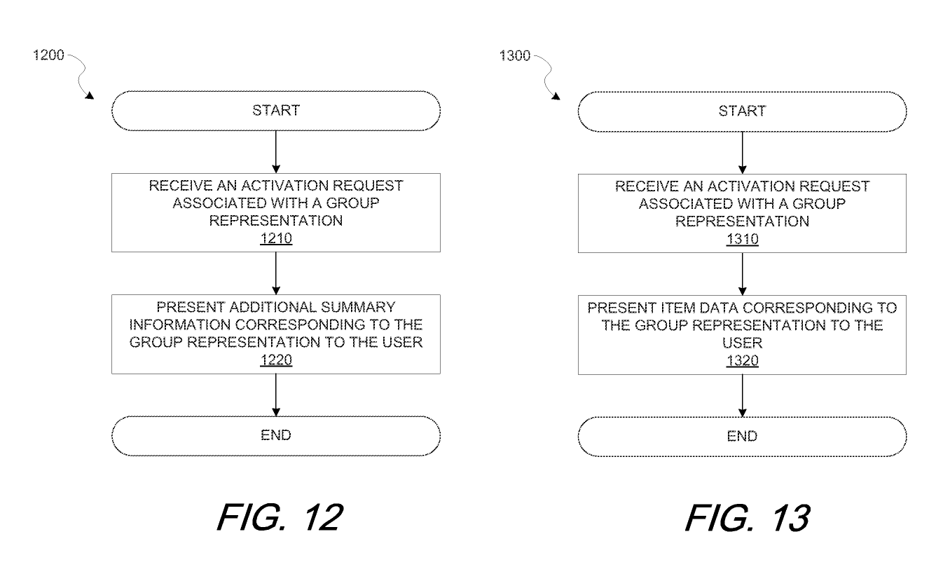

FIGS. 12, 13, and 14 are flow diagrams depicting example user interactions with the group representation. In various embodiments, the group representations are presented to the user and the user may interact with the group representation with a variety of user interactions. The summarizing system 122 may store the user interactions and data associated with the user interactions (e.g., in databases 126) for use in the future by the summarizing system 122.

FIG. 12 is a flow diagram depicting an example embodiment of a user interaction with the group representation. At operation 1210, the summarizing system 122 may receive an activation request associated with the group representation. The activation request may be received from the user (e.g., touching the group representation on a touch screen device). In some example embodiments, the activation request associated with the group representation may be stored and used in the future to generate group representations. For example, the activation request may indicate that the user is interested in the items associated with the item group, and the user's expression of interest may be later used to weight or emphasize those items in the group representation or to identify additional related items and include those items in the item group.

At operation 1220, the summarizing system 122 may present additional summary information corresponding to the group representation to the user. For example, a more detailed summary of the item group may be presented, such as a listing of the items associated with the item group, additional images of the items associated with the item group, and so forth.

FIG. 13 is a flow diagram depicting an example embodiment of a user interaction with the item group. Similar to FIG. 12, at operation 1310, the summarizing system 122 may receive an activation request associated with the group representation.

At operation 1320, the summarizing system 122 may present the item data corresponding to the group representation to the user. For example, the item data may include item listings. The item listings may be presented upon receiving the activation request. The item listings may be used to purchase items on the online marketplace such as marketplace system(s) 120.

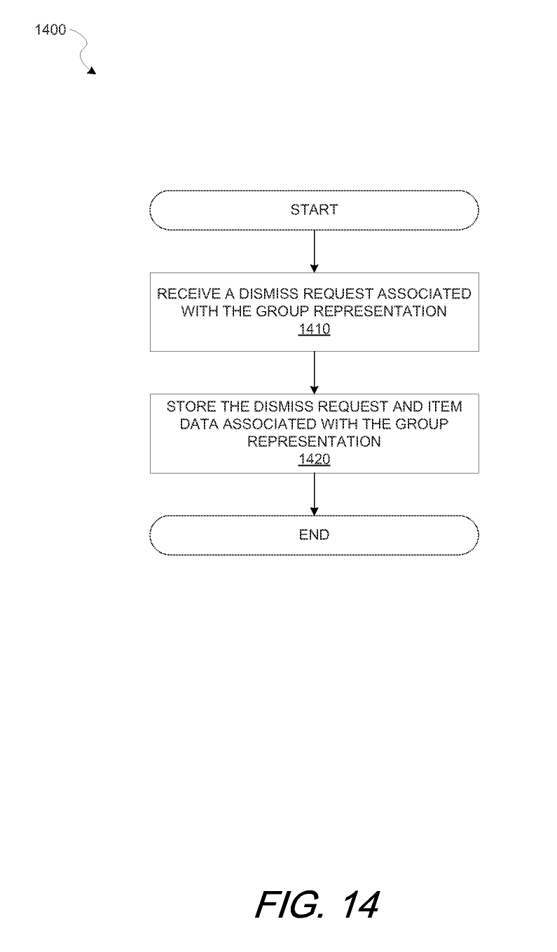

FIG. 14 is a flow diagram depicting an example embodiment of a user interaction with the item group. At operation 1410, the summarizing system 122 may receive a dismiss request associated with the group representations. The dismiss request may be received from the user (e.g., by the user touching the group representation on a touch screen device).

At operation 1420, the summarizing system 122 may store the dismiss request and the item data associated with the group representation. The dismiss request and associated data may be used in the future to generate group representations or determine the item groups. For example, the dismiss request may indicate that the user is not interested in the items associated with the item group and those items may not be included in the item group or used as the basis for the group representation in the future.

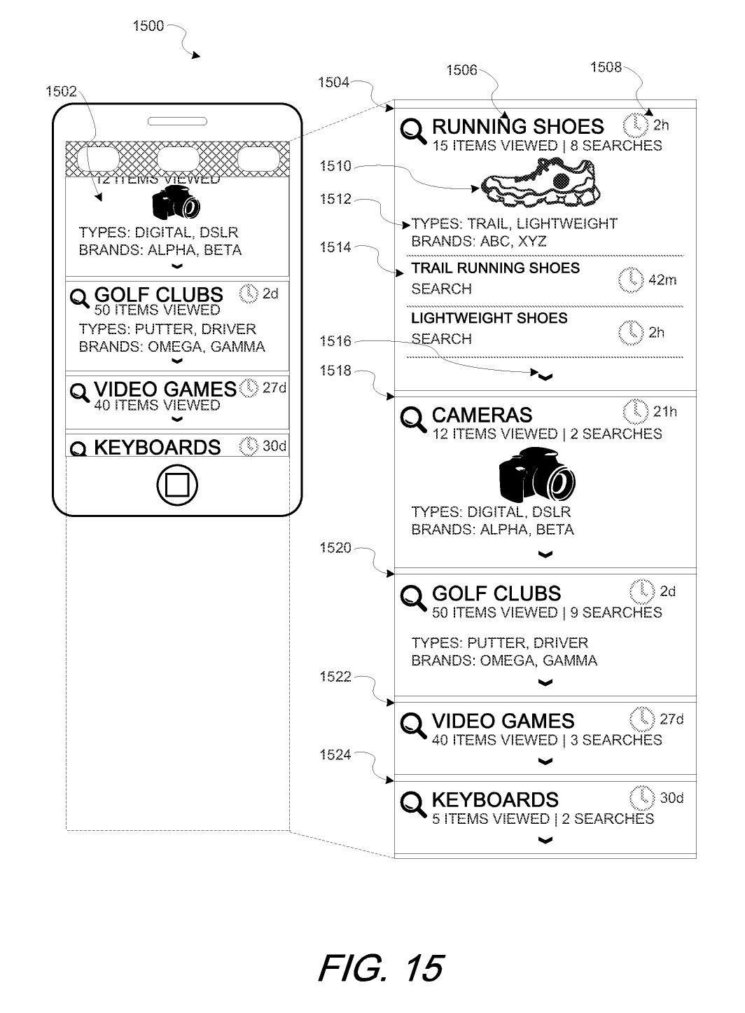

FIG. 15 depicts an example user interface 1500 that may be provided by user interface module 210 and presented to the user. The example user interface 1500 may be presented on a mobile device as depicted by mobile device user interface 1502; however, the example user interface 1500 may be presented on any device operable to present information to the user. The example user interface 1500 may comprise a variety of user interface (UI) elements. The configuration of the UI elements in the example user interface 1500 is merely an example configuration; many other configurations may be employed.

Example group representation 1504 depicts an example embodiment of the group representation. The example group representation 1504 may comprise various text, images, and other forms of media not depicted (audio, animations, and the like). UI element 1506 may be a title of the example group representation 1504 that is representative of the items associated with the item group corresponding to the example group representation 1504. As described here, the UI element 1506, in this example, may be determined from the item data associated with the example group representation 1504. UI element 1508 may be an indication of the temporal data associated with the example group representation 1504. In this example, the searches in the example group representation 1504 may have been performed 2 hours ago. UI element 1510 may be an image that is representative of the items associated with the item group corresponding to the example group representation 1504. As described herein, the images may be accessed from item data associated with a selected item included in the item group (e.g., where there are multiple items associated with the item group, a selected item may be determined, for example, by an item popularity metric such as item page views or other means), may be retrieved from a third party server using item data associated with the item to find a representative image, may be predefined for particular items types, and so forth. UI element 1512 may be a summary of the items associated with the item group corresponding to the example group representation 1504. Many different varieties of summaries may be presented; UI element 1512 is simply an example embodiment. In this embodiment, the summary may be a listing of the types of items and brands of items associated with the item group corresponding to the example group representation 1504. UI element 1514 may be a listing of a particular search or a particular item included in the item data associated with the item group corresponding to the example group representation 1504. UI element 1516 may be an interactive element that, for example, when activated by the user, may provide additional summary information corresponding to the example group representation 1504 or item data corresponding to the example group representation 1504. The activation of UI element 1516 may be stored for use in the future (e.g., the activation may indicate the user is interested in the items and this indication of interest may be used to later emphasize those items when generating a group representation).

Example group representation 1518 depicts another example embodiment of a group representation. The example group representation 1518 may have a lower group resolution than the example group representation 1504. For example, the example group representation 1518 may include fewer images, fewer summary details, and fewer item details as compared to the example group representation 1504. In this example, the example group representation 1518 includes an image and a brief summary of the items associated with the item group corresponding to the example group representation 1518.

Example group representation 1520 is another example embodiment of a group representation. In an example embodiment, the example group representation 1520 may have a lower resolution than the example group representation 1518. In this embodiment, the example group representation 1520 may include a text summary of the items associated with the item group corresponding to the example group representation 1520. Example group representations 1522 and 1524 depict further example embodiments of group representations. In an example embodiment, the example group representations 1522 and 1524 may have the lowest group resolution. In this embodiment, the example group representations 1522 and 1524 may include a title associated with the items associated with the item group corresponding to the example group representations 1522 and 1524.

The example group representations 1504, 1518, 1520, 1522, and 1524 depicted in example user interface 1500 may be sorted. In this example user interface, the group representations are sorted by the item temporal data with the group representation corresponding to the item temporal data nearest the present at the top of the list. The group representations may be sorted using other data and other sorting techniques. In some example embodiments, the group representations may not be sorted in any particular order.

The example group representations 1504, 1518, 1520, 1522, and 1524 depicted in example user interface 1500 may correspond to various item groups that include various items based on various temporal relationships. In this example embodiment, each item group may be associated with items based on temporal relationships, with the range of time associated with the temporal relationships spanning more time when the item temporal data is further in the past. In other words, the item group may encompass a larger time range when the item temporal data is further in the past. In this example embodiment, the most recent group representation may be associated with items corresponding to the item temporal data over a shorter time range (e.g., 2 hours) as compared to the oldest group representation, which may encompass items corresponding to the item temporal data over a longer time range (e.g., a week). Many variations of determining the item group based on the temporal relationships may be employed; this is merely an example embodiment.

In further embodiments, the example group representations 1504, 1518, 1520, 1522, and 1524 depicted in example user interface 1500 may be dismissed. For example, a swipe gesture (e.g., moving a single finger in a horizontal motion while touching a touch screen display) may dismiss the group function. In other embodiments, a user interface element not depicted in example user interface 1500 may be activated to dismiss a group representation. As described herein, the dismissal of a group representation may be stored and used in the future to generate a group representation. In still further embodiments, other interactions with the group representations depicted in example user interface 1500 may be employed. The other interactions may be stored for use in the future.

### Modules, Components, and Logic

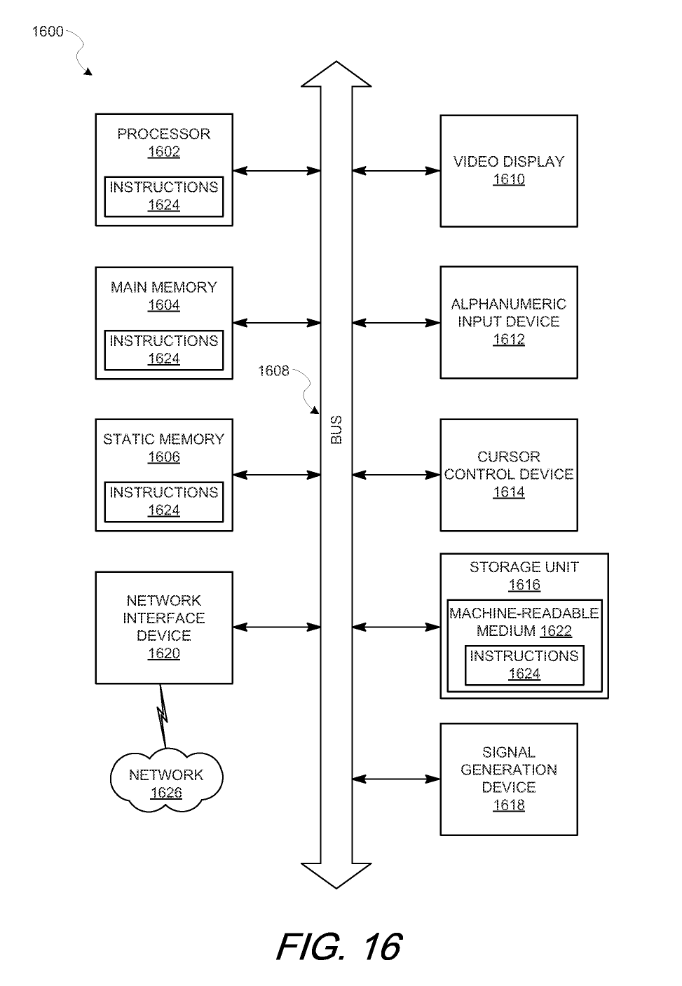

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system and within which instructions 1624 (e.g., software, a program, an application, an applet, an app, or other executable code) for causing the machine 1600 to perform any one or more of the methodologies discussed herein may be executed. In alternative embodiments, the machine 1600 operates as a standalone device or may be connected (e.g., networked) to other machines. In a networked deployment, the machine 1600 may operate in the capacity of a server machine or a client machine in a server-client network environment, or as a peer machine in a peer-to-peer (or distributed) network environment. The machine 1600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1624, sequentially or otherwise, that specify actions to be taken by that machine. Further, while only a single machine is illustrated, the term “machine” shall also be taken to include a collection of machines that individually or jointly execute the instructions 1624 to perform any one or more of the methodologies discussed herein.

The machine 1600 includes a processor 1602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1604, and a static memory 1606, which are configured to communicate with each other via a bus 1608. The machine 1600 may further include a video display 1610 (e.g., a plasma display panel (PDP), a light emitting diode (LED) display, a liquid crystal display (LCD), a projector, or a cathode ray tube (CRT)). The machine 1600 may also include an alphanumeric input device 1612 (e.g., a keyboard), a cursor control device 1614 (e.g., a mouse, a touchpad, a trackball, a joystick, a motion sensor, or other pointing instrument), a storage unit 1616, a signal generation device 1618 (e.g., a speaker), and a network interface device 1620.

The storage unit 1616 includes a machine-readable medium 1622 on which is stored the instructions 1624 embodying any one or more of the methodologies or functions described herein. The instructions 1624 may also reside, completely or at least partially, within the main memory 1604, within the processor 1602 (e.g., within the processor's cache memory), or both, during execution thereof by the machine 1600. Accordingly, the main memory 1604 and the processor 1602 may be considered as machine-readable media. The instructions 1624 may be transmitted or received over a network 1626 via the network interface device 1620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1622 is shown in an example embodiment to be a single medium, the term “machine-readable medium” should be taken to include a single medium or multiple media (e.g., a centralized or distributed database, or associated caches and servers) able to store instructions 1624. The term “machine-readable medium” shall also be taken to include any medium, or combination of multiple media, that is capable of storing instructions (e.g., instructions 1624) for execution by a machine (e.g., machine 1600), such that the instructions, when executed by one or more processors of the machine (e.g., processor 1602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the machine-readable medium is non-transitory in that it does not embody a propagating signal. However, labeling the machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1624 may further be transmitted or received over a communications network 1626 using a transmission medium via the network interface device 1620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A system, comprising:
a hardware processor;
an item data module configured to access item data associated with a user, the item data includes item temporal data;
an item relationship module, executable by the hardware processor, configured to identify item relationships between pieces of the item data that correspond to items, the item relationships include a temporal relationship based on the item temporal data;
an item group module configured to determine an item group associated with at least a portion of the items based on the identified item relationships;
a group representation module configured to generate a group representation that corresponds to the determined item group, the group representation summarizes the items associated with the item group; and
a user interface module configured to cause presentation of the group representation to the user.

2. The system of claim 1, further comprising:
the group representation module further configured to receive an activation request associated with the group representation from the user; and
the user interface module further configured to cause presentation of additional summary information that corresponds to the group representation to the user.

3. The system of claim 1, further comprising:
the group representation module further configured to receive an activation request associated with the group representation from the user; and
the user interface module further configured to cause the presentation of the item data that corresponds to the group representation to the user.

4. The system of claim 1, further comprising:
the group representation module further configured to determine a group resolution value based on the item temporal data associated with the item group and item temporal data associated with other item groups; and
the group representation module configured to generate the group representation includes use of the group resolution value.

5. The system of claim 4, wherein the group resolution value that corresponds to the item temporal data nearest a present time has a highest group resolution value, the group representation that corresponds to the highest group resolution value includes the most summary information.

6. The system of claim 1, wherein the item data is accessed from at least one of a query history of the user, purchase history of the user, and an online marketplace application server.

7. The system of claim 1, wherein the item data includes at least one of item attribute data, item data source, item conversion data, and item engagement data.

8. The system of claim 7, wherein the item relationships include at least one of similarity relationships based on the item attribute data, source relationships based on the item data source, conversion relationships based on the item conversion data, and engagement relationships based on the item engagement data.

9. The system of claim 1, wherein the group representation module configured to generate the group representation includes use of the item data.

10. The system of claim 1, further comprising:
the item data module further configured to:
determine additional items related to the item group; and
retrieve items listings that correspond to the additional items from an online marketplace application server, the item data to include the item listings.

11. The system of claim 1, wherein the item group module configured to determine an item group includes using item data associated with item groups of other users.

12. The system of claim 1, further comprising:
the item data module further configured to:
compile the item data, the item relationships, the item group, and the group representation into a group file, the group file associated with the user;
store the group file in a database; and
communicate, responsive to a group file request from the user, the stored group file to a device of the user.

13. The system of claim 1, further comprising:
the group representation module further configured to receive a dismiss request associated with the group representation from the user;
the user interface module further configured to cause a dismissal of the group representation from presentation; and
the item data module further configured to store the dismiss request and the item data associated with the group representation in a database, the dismiss request and the item data associated with the dismiss request to be used by the group representation module to generate group representations in the future.

14. A method, comprising:
accessing item data associated with a user, the item data including item temporal data;
identifying, using a hardware processor, item relationships between pieces of the item data corresponding to items, the item relationships including a temporal relationship based on the item temporal data;
determining an item group associated with at least a portion of the items based on the identified item relationships;
generating a group representation corresponding to the determined item group, the group representation summarizing the items associated with the item group; and
causing presentation of the group representation to the user.

15. The method of claim 14, further comprising:
receiving an activation request associated with the group representation from the user; and
causing presentation of additional summary information corresponding to the group representation to the user.

16. The method of claim 14, further comprising:
receiving an activation request associated with the group representation from the user; and
causing presentation of the item data corresponding to the group representation to the user.

17. The method of claim 14, further comprising:
determining a group resolution value based on the item temporal data associated with the item group and the item temporal data associated with other item groups; and
the generating the group representation includes using the group resolution value.

18. The method of claim 17, wherein the group resolution value corresponding to the item temporal data nearest a present time has a highest group resolution value, the group representation corresponding to the highest group resolution value including the most summary information.

19. The method of claim 14, wherein the item data is accessed from at least one of a query history of the user, purchase history of the user, and an online marketplace application server.

20. A non-transitory machine readable medium that stores instructions that, when executed by a machine, cause the machine to:
access item data associated with a user, the item data including item temporal data;
identify item relationships between pieces of the item data that correspond to items, the item relationships to include a temporal relationship based on the item temporal data;
determine an item group associated with at least a portion of the items based on the identified item relationships;
generate a group representation that corresponds to the determined item group, the group representation summarizes the items associated with the item group; and
cause presentation of the group representation to the user.
